(19) United States
(12) Patent Application Publication
(10) Pub. No.: US 2022/0103115 A1
(43) Pub. Date: Mar. 31, 2022

(54) RESIDENTIAL STRUCTURE

(71) Applicant: Sony Group Corporation, Tokyo (JP)

(72) Inventor: Yusuke Sakai, Kanagawa (JP)

(73) Assignee: Sony Corporation

(21) Appl. No.: 17/366,581

(22) Filed: Jul. 2, 2021

Related U.S. Application Data
(63) Continuation of application No. 17/039,131, filed on Sep. 30, 2020, now abandoned.

(30) Foreign Application Priority Data
Sep. 30, 2020 (JP) 2019-180445

(51) Int. Cl. H02S 20/23; E04H 15/62; E04H 15/08; H02S 40/36

(52) U.S. Cl. CPC H02S 20/23; E04H 15/62; H02S 40/38; H02S 40/36; E04H 15/08

(57) ABSTRACT

An imaging interval in high-speed continuous shooting imaging can be shortened.

A residential space is constituted by a cloth-like member including a cloth-like tent fabric, a holding member stacked on the tent fabric, and a plurality of panels which are stacked on the holding member and generates power by sunlight. In this case, in the panel, a plurality of panels having the same shape is regularly arranged on a plane at predetermined intervals, the holding member is arranged on a base material in substantially the same size as the panel and at substantially the same position as the panel, and a stretchable member is arranged on the base material between the holding members. As a result, the stretchable member is provided between the panels, so the panels can be repeatedly folded. The present disclosure can be applied to a tent or a tarp.

### CROSS REFERENCE TO RELATED APPLICATIONS

This application claims the benefit of Japanese Priority Patent Application JP 2019-180445 filed on Sep. 30, 2020, the entire contents of which are incorporated herein by reference.

### TECHNICAL FIELD

The present disclosure relates to a residential structure, and more particularly to a residential structure capable of improving durability of a cloth-like part, which has a power generation function, and can be stored and carried in a small size.

### BACKGROUND ART

In an environment where infrastructure is not sufficient, there is a demand for a cloth-like tent in which a residential space is constructed with a configuration that is easy to install, power is generated using natural energy such as sunlight and wind power, and an electronic device is operated by the generated power.

It is conceivable to apply a sheet (see PTL 1) in which a solar power generation panel is attached to such a tent and which can be folded and carried.

### CITATION LIST

### Patent Literature

[PTL 1]
JP 2000-183374 A

### SUMMARY

### Technical Problem

However, in the technique described in PTL 1, folding can be performed at a predetermined boundary, but there is a risk of breakage or tear due to repeated folding at the same boundary, and there is a limit to durability performance.

The present disclosure has been made in view of such a situation, and more particular, is to improve durability of a cloth-like part which has a power generation function and can be stored and carried in a small size.

### Solution to Problem

According to an aspect of the present disclosure, a residential structure is a residential structure in which a residential space is constituted by a cloth-like member including a cloth-like base material, a holding member that is stacked on the base material, and a plurality of panels that are stacked on the holding member and generate power by sunlight, the plurality of panels is regularly arranged on a plane at predetermined intervals, the holding member is arranged on the base material in substantially the same size as the panel and at substantially the same position as the panel, and a stretchable member is arranged on the base material between the holding members.

According to an aspect of the present disclosure, a residential space is constituted by a cloth-like member including a cloth-like base material, a holding member that is stacked on the base material, and a plurality of panels that are stacked on the holding member and generate power by sunlight, the plurality of panels is regularly arranged on a plane at predetermined intervals, the holding member is arranged on the base material in substantially the same size as the panel and at substantially the same position as the panel, and a stretchable member is arranged on the base material between the holding members.

### BRIEF DESCRIPTION OF DRAWINGS

FIG. 1 is a diagram illustrating a configuration example of a telepresence system of the present disclosure.

FIG. 2 is a block diagram for describing a configuration example of a residential structure of the present disclosure.

FIG. 3 is a block diagram illustrating another configuration example of a residential structure of the present disclosure.

FIG. 4 is a diagram for describing functions realized by the residential structure of the present disclosure.

FIG. 5 is an overall configuration diagram of a cloth-like part.

FIG. 6 is an exploded view of a tent fabric in the cloth-like part.

FIG. 7 is an exploded view of a holding member and a power generation panel in the cloth-like part.

FIG. 8 is a side sectional view of the cloth-like part.

FIG. 9 is a diagram for describing wiring between solar cell panels.

FIG. 10 is a diagram for describing a detailed configuration of the wiring.

FIG. 11 is a diagram for describing a modification of the cloth-like part.

FIG. 12 is a diagram for describing a configuration example of a conductive rope.

FIG. 13 is a diagram for describing a configuration example of the conductive rope.

FIG. 14 is a diagram for describing a modification of the conductive rope.

FIG. 15 is a diagram for describing a configuration example of a solid stake.

FIG. 16 is a flowchart for describing telepresence processing.

FIG. 17 is a diagram for describing set-up condition presentation processing.

FIG. 18 is a flowchart for describing the set-up condition presentation processing.

FIG. 19 is a diagram for describing power feeding control processing for assigning power.

FIG. 20 is a diagram for describing power feeding control processing for assigning power.

FIG. 21 is a flowchart for describing the power feeding control processing.

FIG. 22 is a diagram for describing a configuration example of a general-purpose personal computer.

### DESCRIPTION OF EMBODIMENTS

Hereinafter, preferred embodiments of the present disclosure will be described in detail with reference to the accompanying drawings. Note that in the specification and the drawings, components having substantially the same functional configuration are denoted by the same reference numerals, and a redundant description thereof is omitted.

Hereinafter, modes for carrying out the present technology will be described. Note that the description will be given in the following order.

1. Configuration Example of Telepresence System

2. Configuration Example of Cloth-like Part

3. Modification of Cloth-like Part

4. Conductive Rope

5. Modification of Conductive Rope

6. Configuration Example of Solid Stake

7. Telepresence Processing

8. Presentation of Set-up Condition Including Direction and Attitude of Residential Structure Optimum for Power Generation

9. Power Feeding Control for Assigning Power

10. Example Executed by Software

### Preferred Embodiment

1. Configuration Example of Telepresence System

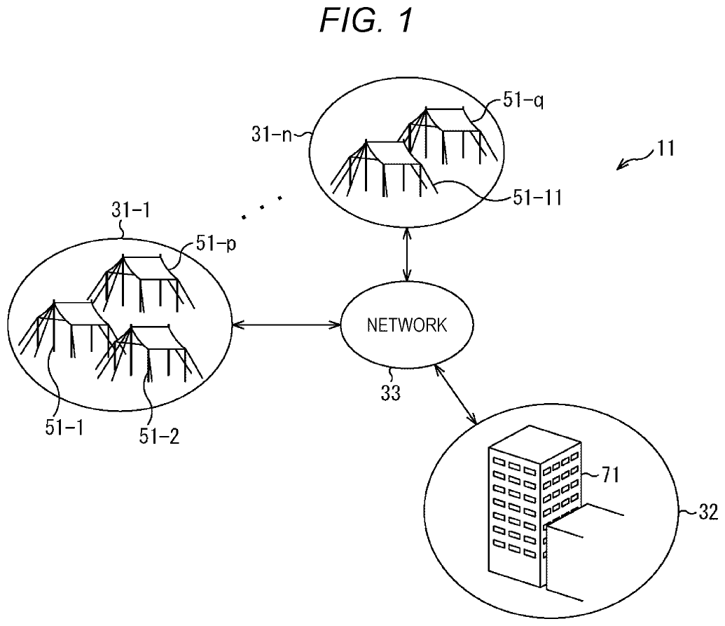

FIG. 1 is a configuration example of a telepresence system including a residential structure of the present disclosure.

The telepresence system 11 in FIG. 1 includes a cluster 31-1 including residential structures 51-1 to 51p, a cluster 31n including residential structures 51-11 to 51q, a cluster 32 including a structure 71, and a network 33.

Note that in a case where there is no particular need to distinguish between clusters 31-1 to 31-n and residential structures 51-1 to 51-p and 51-11 to 51-q, the clusters 31-1 to 31-n and the residential structures 51-1 to 51-p and 51-11 to 51-q will be simply referred to as a cluster 31, and other configurations are also similarly referred to.

The residential structure 51 is, for example, a tent, a tarp, a shelter, or the like, which is installed in an environment where normal infrastructure is not configured, and constructs a residential space by a cloth-like part having a power generation function.

The residential structure 51 implements a telepresence function by operating an information processing apparatus having a communication function by power generated by a cloth-like part having power generation function and communicating with each other via a network 33.

Here, the telepresence function is a function of establishing communication between the residential structures 51 in remote locations and mutually transmitting and receiving images or sounds in a space in the residential structure 51 to share natural conversations, environment sounds, or document data.

Therefore, by implementing the telepresence function, it is possible to share the natural conversations, the environment sounds, or the document data between the residential structures 51.

In addition, the residential structures 51-1 to 51p and 51-11 to 51q and the residential structure 71 constitute clusters 31-1 to 31n and a cluster 32, respectively.

The cluster 31 includes a plurality of residential structures 51 groups existing at spatially close locations, and is configured so that power generated in each of the residential structures 51 in the cluster 31 is assigned between the residential structures 51 according to power consumption or the like.

The residential structure 71 is a general building structure such as a building, and the cluster 32 includes a plurality of information processing apparatus groups (not illustrated) inside the structure 71.

### Configuration Example of Residential Structure

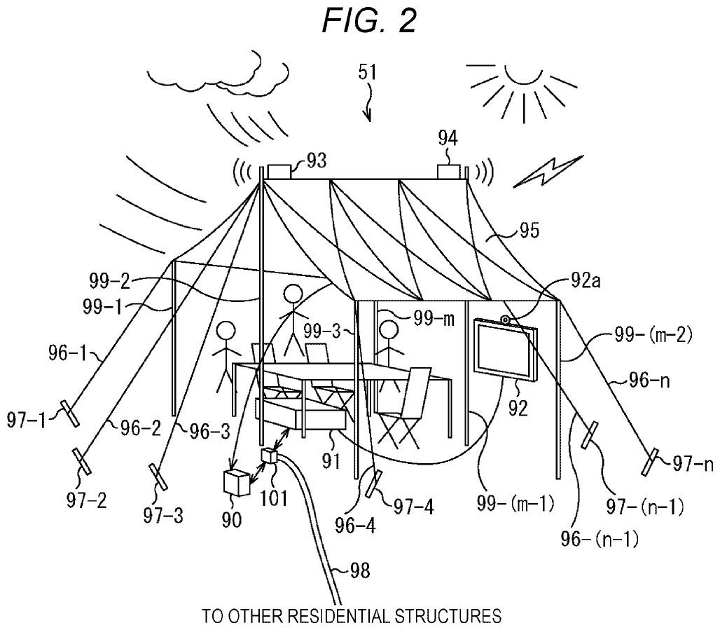

Next, a configuration example of the residential structure 51 will be described with reference to FIG. 2. The residential structure 51 includes a battery 90, an information processing apparatus 91, a display unit 92, an environment sensor 93, an antenna 94, a cloth-like part 95, conductive ropes 96-1 to 96n, solid stakes 97-1 to 97n, conductive ropes 98, poles 99-1 to 99m, and a power feeding unit 101.

The residential structure 51 has, for example, a configuration based on a tent or a tarp as illustrated in FIG. 2, and a tent fabric including the cloth-like part 95 having a power generation function is supported by a pole 99 to be used as a ceiling, and a residential space is formed under the tent fabric.

In addition, poles 99-1 to 99m performs the support in a state in which a portion of the cloth-like part 95 is hung on a tip and in a state in which conductive ropes 96-1 to 96n having a conductive function are connected from an opposite direction to the cloth-like part 95, and tension is applied to a ground direction so that the cloth-like part 95 is spread like a ceiling.

In addition, the conductive rope 96 is applied with the tension in a state in which one end portion is connected to the tip of the pole 99 and a portion of the cloth-like part 95 and the other end portion is connected to a solid stake 97 functioning as a peg having a grounding function.

The conductive rope 96 has a function as a rope that supports the pole 99 and a function of securing a ground potential with respect to the cloth-like part 95 having a power generation function by having conductivity.

That is, the conductive rope 96 has a function of generating tension on the pole 99 supporting the cloth-like part 95 in the spread state, and securing a ground potential by connecting the cloth-like part 95 having the power generation function to the solid stake 97 having a ground function.

As a result, even when a power generation amount is to be increased by connecting the plurality of cloth-like parts 95, a ground potential is reliably secured, so it is possible to reduce a decrease in power generation efficiency and a power transmission loss caused by a deviation of a reference potential.

In addition, in the cloth-like part 95, even when an electric leak occurs, since the ground potential is secured, it is possible to release power generated by the electric leak to the ground, and thus, it is possible to suppress an electric shock accident or the like caused by inadvertent touch by a user.

The battery 90 includes, for example, an orbic acid battery or the like, and functions as a power storage unit that stores power generated by the cloth-like part 95 having the power generation function, and supplies power to the information processing apparatus 91 and the like via the power feeding unit 101.

The information processing apparatus 91 includes, for example, a personal computer or the like, and controls the entire operation of the residential structure 51 by receiving power supply from the power feeding unit 101.

The display unit 92 is controlled by the information processing apparatus 91 and includes a liquid crystal display (LCD), an organic electro-luminescence (EL), a projector, and the like, and displays various types of information. In addition, the display unit 92 incorporates an imaging unit 92a, captures an image in the residential structure 51, collects sound, and outputs the sound to the information processing apparatus 91.

That is, the information processing apparatus 91 implements the telepresence function between the other residential structure 51, transmits the image and sound captured by the imaging unit 92a to the other residential structures 51 via the conductive rope 98, receives the image and sound transmitted from the other residential structure 51, and displays the image and sound on the display unit 92.

The environment sensor 93 is a sensor that detects environment information around the residential structure 51, and includes, for example, a GPS sensor together with at least one of an illuminance sensor, a wind power sensor, a rainfall sensor, a temperature sensor, an atmospheric pressure sensor, a humidity sensor, and the like, and supplies each sensing result and its own position information to the information processing apparatus 91.

The information processing apparatus 91 predicts a power generation amount after a predetermined time elapses from information on various sensing results and surrounding topography based on its own position information, and presents set-up conditions such as a direction and an attitude of the residential structure 51 optimum for power generation.

The cloth-like part 95 includes, for example, a plurality of solar power generation panels arranged on a cloth-like tent fabric or the like, and functions as a roof of the residential structure 51 by being supported by the poles 99 and being developed in the air.

In addition, the cloth-like part 95 generates power according to the illuminance, and supplies the power to the battery 90 to store the power or directly supplies the power to the power feeding unit 101.

With the above configuration, even in an environment where infrastructure such as power is not sufficiently arranged, a residential space is constructed, and power generation based on natural energy is implemented, and the information processing apparatus 91 is operated by the generated power to implement the telepresence function.

Note that, in the above, an example of using solar power generation has been described as the power generation function, but other configurations may be used as long as power can be generated by natural energy, and for example, wind power generation using a wind turbine or the like may be used.

### OTHER CONFIGURATION EXAMPLES OF RESIDENTIAL STRUCTURE

In the above description, a configuration example based on tents and tarp has been described as a configuration example of the residential structure. However, for example, a configuration based on a vehicle-type cabin may be used.

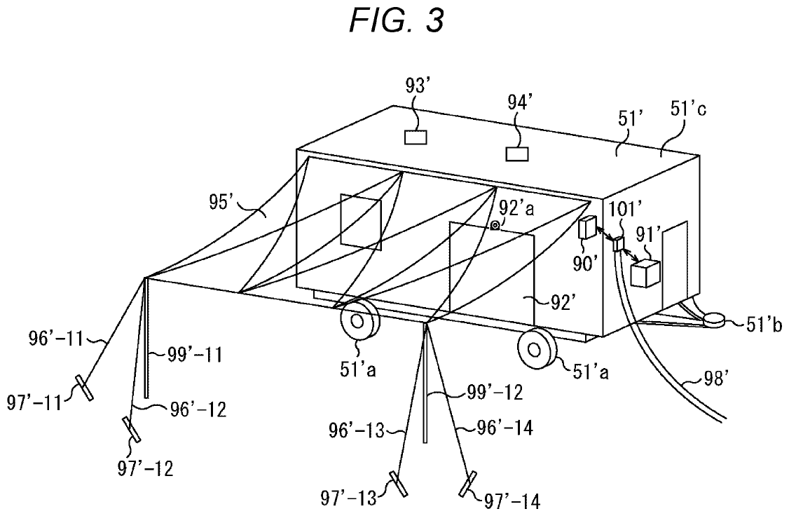

FIG. 3 is a diagram illustrating a configuration example of a residential structure 51′ based on a vehicle-type cabin.

Note that, for configurations corresponding to those in the residential structure 51 in FIG. 2, “′” is added to the reference numerals, and the description thereof will be omitted as appropriate.

That is, the residential structure 51′ in FIG. 3 includes a battery 90′, an information processing apparatus 91′, a display unit 92′, an environment sensor 93′, an antenna 94′, a cloth-like part 95′, conductive ropes 96′-11 to 96′-14, solid stakes 97′-11 to 97′-14, a conductive rope 98′, poles 99′-11 and 99′-12, and a power feeding unit 101′.

The residential structure 51′ has a body constituted by a vehicle-type cabin 51c′.

In addition, in the residential structure 51′, a lower portion of the cabin 51c′ is provided with four wheels 51a′, and an end portion thereof is provided with a traction hook 52b′, and as a result, can be towed and moved by a traction track (not illustrated) or the like. In addition, one side surface portion of the cloth-like part 95′ is connected to a side surface portion of the cabin 51′c of the residential structure 51′, and the other side surface portion of the cloth-like part 95′ facing the side surface portion of the residential structure 51′ is supported by poles 99′-11 and 99′-12. Even in the residential structure 51′ of FIG. 3, in an environment where infrastructure such as power is not sufficiently arranged, a residential space is constructed, and power generation based on natural energy including sunlight is implemented, and an information processing apparatus 91′ is operated by the generated power to realize a telepresence function.

Note that, hereinafter, the description will proceed mainly on the configurations of the battery 90 to the power feeding unit 101 of the residential structure 51, but the configurations of the battery 90′ to the power feeding unit 101′ of the residential structure 51′ also function similarly.

<Function Implemented by Residential Structure>

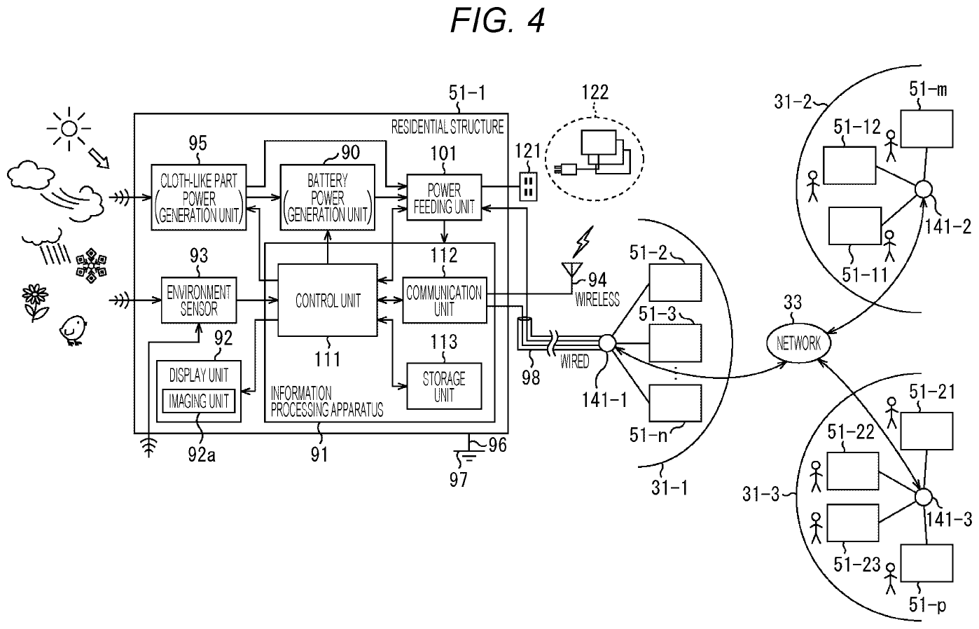

Next, functions implemented by the residential structure 51 will be described with reference to the block diagram of FIG. 4.

The functions implemented by the residential structure 51 include a battery (power storage unit) 90, an information processing apparatus 91, a display unit 92, an environment sensor 93, an antenna 94, a cloth-like part (power generation unit) 95, a conductive rope 96, a solid stake 97, a conductive rope 98, and a power feeding unit 101.

Furthermore, the information processing apparatus 91 includes a control unit 111, a communication unit 112, and a storage unit 113.

The control unit 111 includes a processor, a memory, and the like, and controls the entire operation of the residential structure 51 using various programs and data stored in the storage unit 113 that includes a hard disc drive (HDD), a solid state drive (SSD), and the like.

In addition, the communication unit 112 achieves communication with the other residential structure 51 in the same cluster 31-1 via a hub 141-1 connected to the other residential structure 51 in the same cluster 31-1 via a conductive rope 98.

Furthermore, the communication unit 112 implements, via the conductive rope 98, communication with the hub 141-1 in the same cluster 31-1 and the other residential structures 51 in other clusters 31-2 and 31-3 via each hub 141-2 and 141-3 of the other clusters 31-2 and 31-3.

In addition, the residential structures 51 assign power between the other residential structure 51 in the same cluster 31.

The power feeding unit 101 is controlled by the control unit 111, and performs power transmission to the other residential structure 51 and power reception from the other residential structure 51 via the conductive rope 98.

That is, the conductive rope 98 is a cable in which wiring related to communication with the other residential structures 51 in the same cluster 31 and in the other cluster 31 and wiring for transmitting and receiving power to and from the other residential structure 51 in the same cluster 31 are mixed.

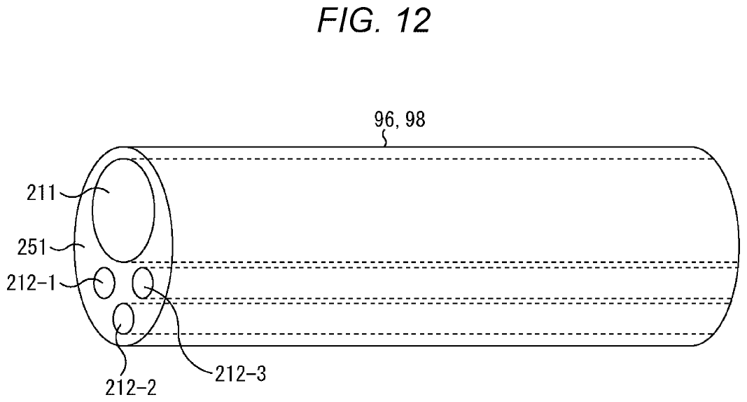

Note that a detailed configuration of the conductive rope 98 will be described later with reference to FIGS. 12 to 14.

Furthermore, the communication unit 112 implements short-range communication in the residential structure 51 by, for example, a wireless local area network (LAN) or the like via the antenna 94.

In addition, the control unit 111 implements a telepresence function.

That is, the control unit 111 controls the communication unit 112 to establish communication with the other residential structures 51 in the same cluster 31-1 and the other clusters 31-2 and 31-3 to transmit the image and sound in the residential structure 51 captured by the imaging unit 92a to the other residential structures 51, receive the image and sound in the other residential structures 51, and display the image and sound on the display unit 92, thereby implementing the telepresence function.

The control unit 111 controls the cloth-like part 95 functioning as a power generation unit, the battery 90 functioning as a power storage unit, and the power feeding unit 101 to store the power generated by the cloth-like part 95 in the battery 90 or directly output the power from the cloth-like part 95 to the power feeding unit 101.

The control unit 111 controls the power feeding unit 101 on the basis of the power generation amount by the cloth-like part 95 and the power consumption recognized from the power feeding amount of the power feeding unit 101 to promote coordination between the other residential structures 51 in the same cluster 31 and control power assignment.

The control unit 111 predicts a power generation amount by the cloth-like part 95 from the sensing result of the environment sensor 93 and the information of the surrounding topography obtained from the position information, estimates set-up conditions including a direction and an attitude of the residential structure 51 for optimizing the power generation amount, and presents the set-up conditions on the display unit 92.

In this case, the control unit 111 estimates the optimum set-up conditions in consideration of the environment load on the residential structure 51.

The environment load described here is, for example, a load on the residential structure 51 from the natural environment, such as a strong wind and a snowfall, and is an index for evaluating whether or not the residential structure 51 can be safely set up within a range of wind resistance performance against the strong wind or load resistance performance against a weight of snow cover at the time of snowfall by changing set-up conditions.

Therefore, when the environment load is too large, since it is difficult to safely set up the residential structure 51 even if the power generation efficiency is the highest, the control unit 111 optimizes the power generation efficiency within a range in which safety can be secured on the basis of the environment load.

More specifically, the control unit 111 estimates environment conditions after a predetermined time elapses on the basis of the sensing result and the surrounding topography obtained from the position information, estimates the power generation efficiency and the environment load under the estimated environment condition, and presents the set-up conditions in which the power generation efficiency is higher than a predetermined order among the set-up conditions in which safety is ensured for the estimated environment load.

The power feeding unit 101 is controlled by the control unit 111 to feed the power supplied from the cloth-like part 95 and the battery 90 to the other residential structure 51 via the conductive rope 98, or to feed the power to, for example, the other home electric appliances 122 from an outlet 121 provided outside.

### 2. Configuration Example of Cloth-like Part

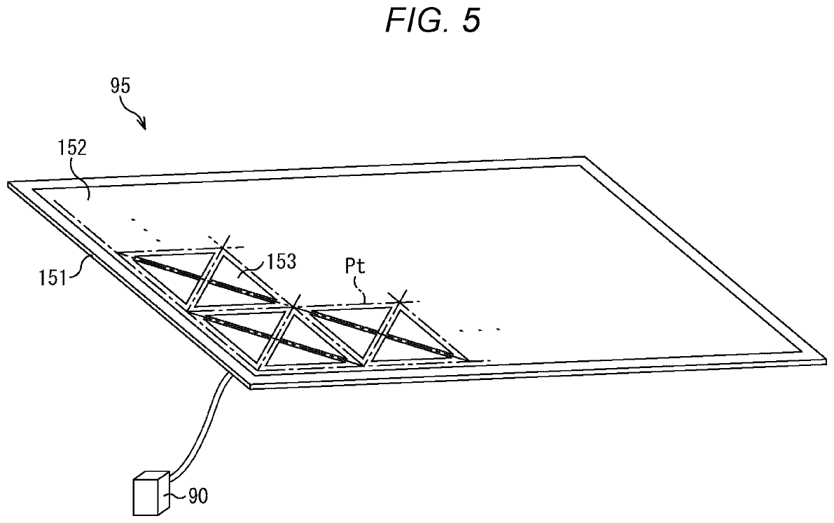

Next, a configuration example of the cloth-like part 95 will be described with reference to FIGS. 5 to 10.

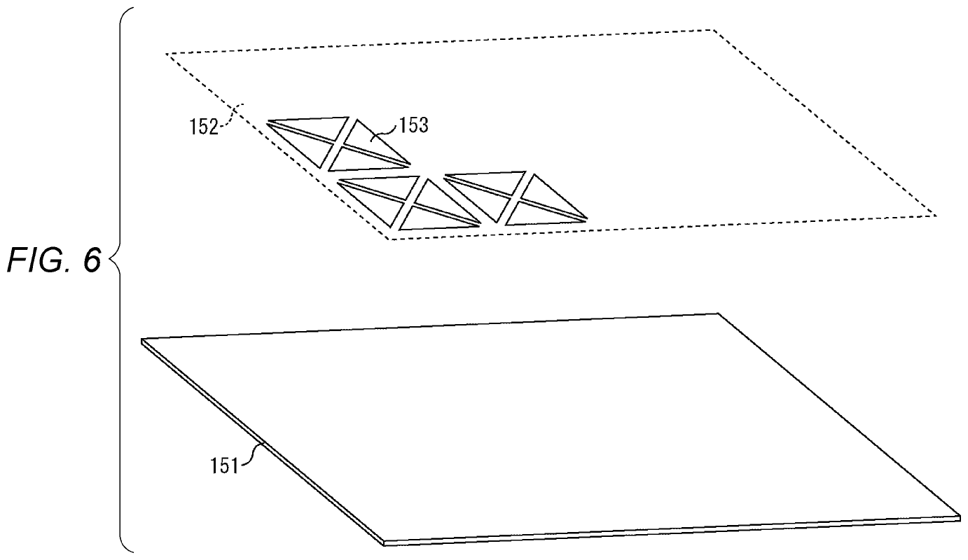

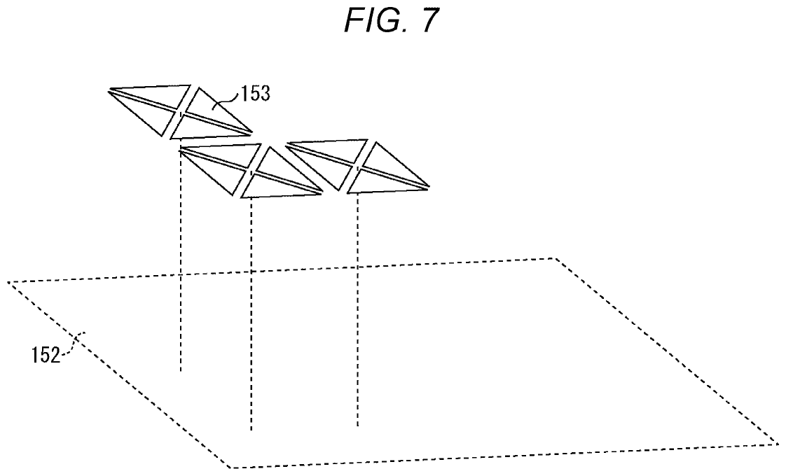

Note that FIG. 5 is an overall configuration diagram of the cloth-like part 95, FIG. 6 is an exploded view of a tent fabric 151 in the cloth-like part 95, and FIG. 7 is an exploded view of a holding member 152 and a power generation panel 153 in the cloth-like part 95.

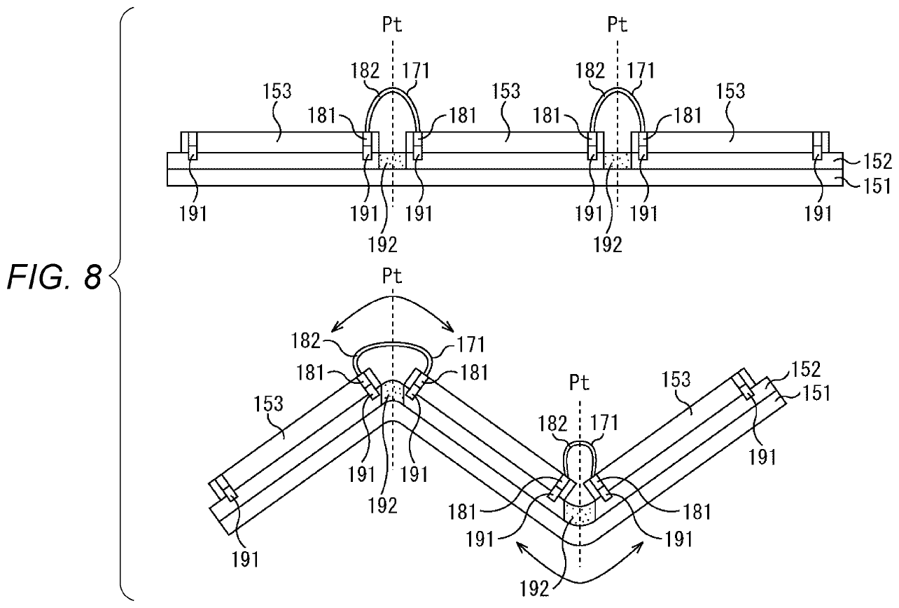

In addition, an upper portion of FIG. 8 is a side sectional view of the cloth-like part 95, and a lower portion of FIG. 8 is a side sectional view illustrating that the cloth-like part 95 is bent by a fold Pt.

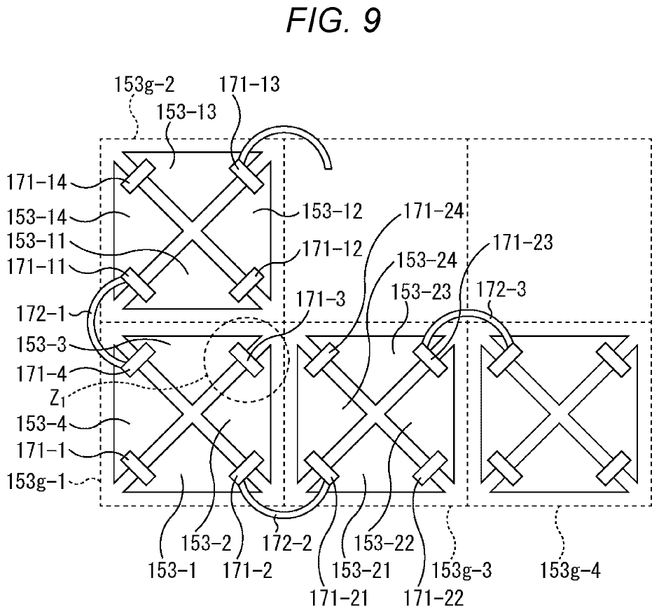

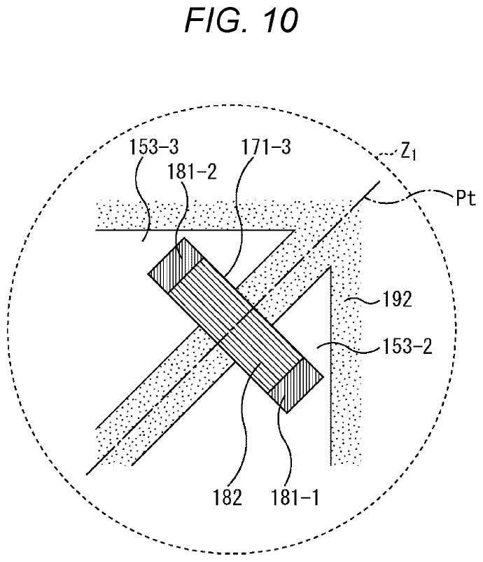

Furthermore, FIG. 9 is a diagram for describing connection wiring 171 between power generation panels 153, and FIG. 10 is a diagram for describing a detailed configuration of the wiring 171.

That is, as illustrated in FIGS. 5 to 8, the cloth-like part 95 has a configuration in which a tent fabric 151, a holding member 152, and a power generation panel 153 are stacked in this order from the bottom in the figure.

The tent fabric 151 includes a flexible cloth-like material used for general tents, tarps, and the like.

In addition, the holding member 152 includes a flexible material, includes a printed circuit board (not illustrated), has substantially the same shape as the power generation panel 153, is stacked between the power generation panel 153 and the tent fabric 151, and is electrically connected to the power generation panel 153.

The power generation panel 153 is a solar power generation panel having a substantially right-angled isosceles triangle, and four power generation panels 153 are arranged in a rectangular shape by having their right-angled vertices face each other and two equal sides of the power generation panel 153 be disposed adjacent to each other, and are arranged so as to be adjacent in a matrix form in horizontal and vertical directions in units of the four power generation panels 153 arranged in the rectangular shape.

In addition, as illustrated in FIG. 8, a stretchable member 192 including a resin member is provided between the holding members 152 provided below adjacent power generation panels 153.

Therefore, as illustrated in FIG. 5, the alternate long and short dash line portion between the adjacent power generation panels 153 is formed as the fold Pt of the cloth-like part 95.

As a result, as illustrated in the lower part of FIG. 8, the cloth-like part 95 can be bent along the fold Pt. Furthermore, as illustrated in FIGS. 8 and 9, in power generation panel 153, terminals 191 at bottom corner portions at both end of a long side in the substantially right-angled isosceles triangular configuration are electrically connected by connection wiring 171 that includes a terminal 181 and wiring 182. In addition, the terminal 191 of the power generation panel 153 is electrically connected to the holding member 152.

More specifically, as illustrated in FIG. 9, the power generation panels 153-1 to 153-4 constitute a group 153g-1.

In the group 153g-1, the power generation panels 153-1 and 153-2 are electrically connected by connection wiring 171-2, the power generation panels 153-2 and 153-3 are electrically connected by connection wiring 171-3, the power generation panel 153-3 and 153-4 are electrically connected by connection wiring 171-4, and the power generation panels 153-4 and 153-1 is electrically connected by connection wiring 171-1.

In addition, the power generation panels 153-11 to 153-14 constitute a group 153g-2.

In the group 153g-2, the power generation panels 153-11 and 153-12 are electrically connected by connection wiring 171-12, the power generation panels 153-12 and 153-13 are electrically connected by connection wiring 171-13, the power generation panel 153-13 and 153-14 are electrically connected by connection wiring 171-14, and the power generation panels 153-14 and 153-11 is electrically connected by connection wiring 171-11.

In addition, the power generation panels 153-21 to 153-24 constitute a group 153g-3.

In the group 153g-3, the power generation panels 153-21 and 153-22 are electrically connected by connection wiring 171-22, the power generation panels 153-22 and 153-23 are electrically connected by connection wiring 171-23, the power generation panel 153-23 and 153-24 are electrically connected by connection wiring 171-24, and the power generation panels 153-24 and 153-21 is electrically connected by connection wiring 171-21.

Then, in the groups 153g-1 and 153g-2 of the power generation panel 153, the connection wirings 171-4 and 171-11 is electrically connected by interconnection wiring 172.

In the groups 153g-1 and 153g-3, the connection wiring 171-2 and 171-21 is electrically connected by the interconnection wiring 172-2.

The groups 153g-3 and 153g-4 are electrically connected by the interconnection wiring 172-3.

That is, the adjacent power generation panels 153 in the group 153g are electrically connected by the connection wiring 171, and the adjacent groups 153g are electrically connected by the interconnection wiring 172. Then, the power generation panels 153 are arranged in a matrix form in units of groups 153g.

The whole power generation panel 153 is electrically connected by such wiring.

In addition, as illustrated in FIG. 10, in the vicinity of the bottom angle of the power generation panels 153-2 and 153-3, which is a detailed configuration of region Z1 in FIG. 9, the terminals 181-1 and 181-2 of the connection wirings 171 are electrically connected to each other via wirings 182.

In addition, a stretchable member 192 including a resin having stretchability is provided between the power generation panels 153-2 and 153-3, and the fold Pt is formed.

With such a configuration, as described above, as illustrated in the lower portion of FIG. 8, it can be bent by the fold Pt.

As a result, when housing the residential structure 51, the cloth-like part 95 can be detached and folded along the fold Pt to be housed.

Further, since the number of folds Pt per area of cloth-like part 95 can be set to the number corresponding to the size of power generation panel 153, the folds Pt can be made with different folds Pt even when folded repeatedly.

For this reason, it is possible to reduce a risk of breakage or tear caused by repeatedly folding the creases at the same position, and as a result, it is possible to improve durability.

<<3. Modification of Cloth-like Part>>

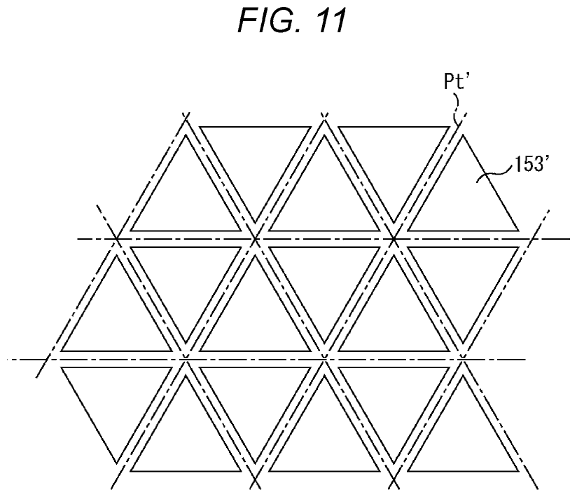

In the above description, an example has been described in which the cloth-like part 95 is constituted by the power generation panel 153 having a right-angled isosceles triangle. However, the shape of the power generation panel 153 may be another shape, and the cloth-like part 95 may be constituted by a power generation panel 153′ having an equilateral triangle, for example, as illustrated in FIG. 11.

The power generation panel 153′ of FIG. 11 is planarly arranged so that each side face each other, and thus, the fold Pt′ is formed as indicated by the one-dot chain line.

With such a configuration, as illustrated in FIG. 11, the cloth-like part 95 can be bent along different folds Pt′ even when folding repeatedly since the number of folds Pt′ corresponding to the size of the power generation panel 153′ can be set.

For this reason, it is possible to reduce a risk of breakage or tear caused by repeatedly folding the creases at the same position, and as a result, it is possible to improve durability.

Note that the wiring configuration of the cloth-like part 95 including the power generation panel 153′ is a configuration corresponding to the power generation panel 153 having the right-angled isosceles triangle, the holding member 152′ under the power generation panel 153′ is also formed in a substantially equilateral triangle, and furthermore, the stretchable member 192′ including a resin is further provided between the holding members 152′, so the fold Pt′ is formed.

<<4. Conductive Rope>>

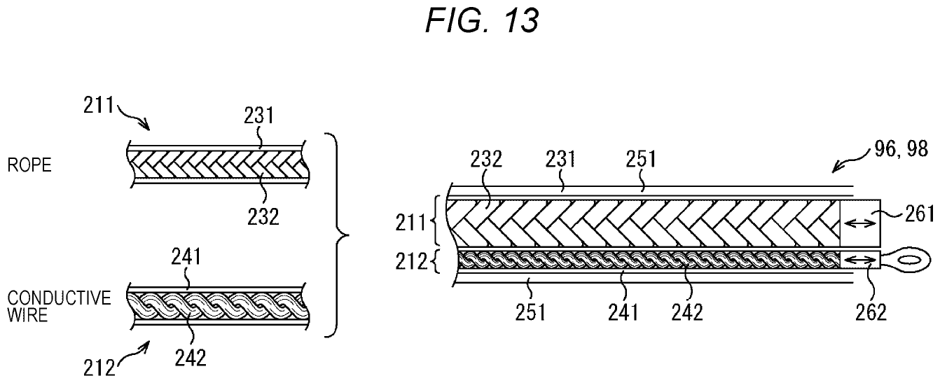

Next, a configuration example of the conductive ropes 96 and 98 will be described with reference to FIGS. 12 and 13. Note that FIG. 12 is a transparent view of the conductive ropes 96 and 98, FIG. 13 is a side cross-sectional view, and FIG. 13 illustrates only one conductive wire 212 out of the conductive wires 212-1 to 212-3.

The conductive ropes 96 and 98 include a rope 211 and conductive wires 212-1 to 212-3 including metal leads constituting a power transmission line and a communication line.

The rope 211 includes a strength fiber 232 having flexibility for coping with a load in a natural environment in which fluctuations are severe in addition to hardness and strength for withstanding tight cutting, and a cloth coating 231 coating the strength fiber 232. The conductive wire 212 includes a low resistance metal lead wire 242 for transmitting and receiving power used for electrical products and the like and transmitting and receiving various signals related to communication, and a rubber insulation film 241 covering the metal lead wire 242.

Then, in the conductive ropes 96 and 98, the rope 211 and the conductive wires 212-1 to 212-3 constituting the power transmission line and the communication line are covered with a water-resistant cloth coating 251.

Furthermore, in the conductive ropes 96 and 98, expansion/contraction adjusting units 261 and 262 are provided at each end portion of the rope 211 and the conductive wire 212, and a length of a portion taken out from the water-resistant cloth coating 251 can be adjusted.

With such a configuration, the conductive ropes 96 and 98 have a function as a rope used for normal tents and tarps and a function as a so-called electric wire used for transmitting and receiving signals or transmitting and receiving signals related to communication.

Note that, although the configurations of the conductive ropes 96 and 98 are the same, the purpose of use is different. That is, the purpose of the conductive rope 96 is to tension the cloth-like part 95 and to secure the ground potential.

On the other hand, in the conductive rope 98, a portion of the plurality of conductive wires 212 is used for the purpose of power transmission and reception, and the other portion are used for the purpose of transmitting and receiving a signal related to communication.

As a matter of course, the cloth-like part 95 may be tensioned in the conductive rope 98.

<<5. Modification of Conductive Rope>>

In the above description, an example has been described in which the rope 211 and the conductive wires 212-1 to 212-3 constituting the power transmission line and the communication line are wired on different axes in the conductive ropes 96 and 98, respectively, but may be wired coaxially.

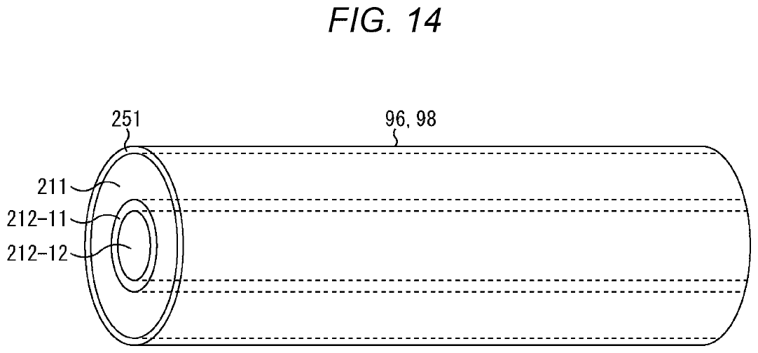

For example, as illustrated in FIG. 14, the conductive wire 212-11 having a minimum diameter with respect to the central axis may be formed, the conductive wire 212-11 may be formed so as to cover the conductive wire 212-12, the rope 211 may be formed so as to cover the conductive wire 212-12, and the rope 211 may be covered with the water-resistant cloth coating 251.

In this manner, the rope 211 and the conductive wire 212-11,212-12 may be configured coaxially.

However, even in the conductive ropes 96 and 98 in FIG. 14, it is desirable to provide a configuration corresponding to the expansion/contraction adjusting unit 261 at the end portion of the rope 211 and a configuration corresponding to the expansion/contraction adjusting unit 262 at the end portions of the conductive wires 212-11 and 212-12.

### 6. Configuration Example of Solid Stake

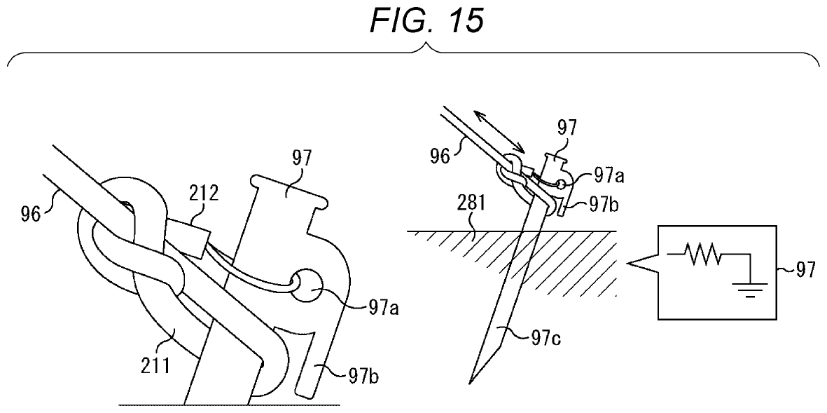

Next, a configuration example of the solid stake 97 will be described with reference to FIG. 15.

The solid stake 97 have a function as a ground circuit as illustrated in the right part of FIG. 15 in a configuration functioning as a so-called metal peg.

That is, as illustrated in the right part of FIG. 15, the solid stake 97 includes a conductive metal, and includes a hole part (grounding part) 97a that connects the conductive wires 212 of the conductive ropes 96 and 98, a claw part 97b that connects the ropes 211 of the conductive ropes 96 and 98, and a peg part 97c embedded in a ground 281.

As illustrated in the left part of FIG. 15, the conductive wire 212 of each of the conductive ropes 96 and 98 is connected to the hole part 97a, and the rope 211 of each of the conductive ropes 96 and 98 is connected to the claw part 97b.

As a result, the conductive wire 212 passing through the hole part 97a is electrically connected to the solid stake 97, and the peg part 97c is embedded in the ground 281, so the ground potential can be secured.

Further, the rope 211 is physically tied and connected to the claw part 97b, so tension can be applied to the pole 99, and the cloth-like part 95 can be spread and stretched like a ceiling as a whole.

<<7. Telepresence Processing>>

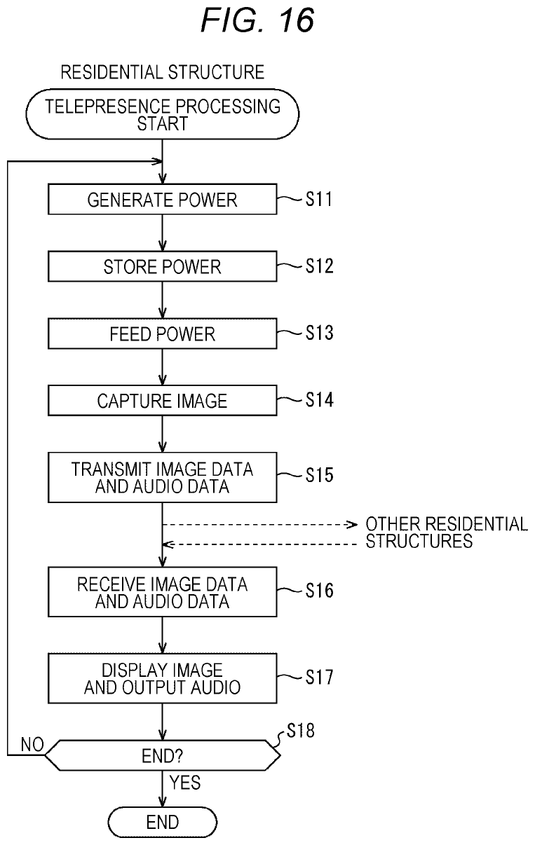

Next, telepresence processing will be described with reference to a flowchart in FIG. 16. Note that this processing is based on the premise that communication with the residential structures 51-1 and 51-2 that are to mutually implement the telepresence processing are established in advance.

In step S11, the control unit 111 controls the cloth-like part 95 functioning as the power generation unit to generate power, and depending on the situations, outputs the whole to the power feeding unit 101, the whole to the battery 90 functioning as the power storage unit, or a part to the power feeding unit 101, and the other part to the battery 90. In this case, the control unit 111 may cause the power feeding unit 101 to feed power from the battery 90 as necessary.

In step S12, the control unit 111 controls the battery 90 functioning as the power storage unit to store the power supplied from the cloth-like part 95.

In step S13, the control unit 111 controls the power feeding unit 101 to feed power to various power facilities including the information processing apparatus 91.

In step S14, the control unit 111 controls the imaging unit 92a of the display unit 92 to image a predetermined range in the residential space of the residential structure 51, and to collect sound by a built-in microphone (not illustrated) or the like.

In step S15, the control unit 111 generates image data and audio data including the captured image and the collected sound, and controls the communication unit 112 to transmit the image data and the audio data to other residential structure 51 via the conductive rope 98 and the hub 141.

In step S16, the control unit 111 controls the communication unit 112 to receive the image data and the audio data including the captured image and the collected sound in the other residential structure 51 via the hub 141 and the conductive rope 98.

In step S17, on the basis of the received image data and audio data, the control unit 111 causes the display unit 92 to display an image and causes a speaker (not illustrated) or the like to output sound.

In step S18, the control unit 111 determines whether or not an instruction to end the processing has been given, and in a case where the instruction has not been given, the process returns to step S11.

That is, the processing of steps S11 to S18 is repeated until the end is instructed.

Then, in a case where it is determined in step S18 that the end instruction has been given, the processing ends. With the above processing, even in the environment where infrastructure is not sufficient, it is possible to generate power with natural energy such as sunlight and cover the power in the residential structure 51. In addition, it is possible to realize telepresence between the other residential structures 51 for which communication has been established by using power generated on the basis of the natural energy by an image, a sound, or the like.

As a result, it is possible to provide a communication environment as if one were in the same space even in the environment where the infrastructure is not sufficient.

<<8. Presentation of Set-up Condition Including Direction and Attitude of Residential Structure Optimum for Power Generation>>

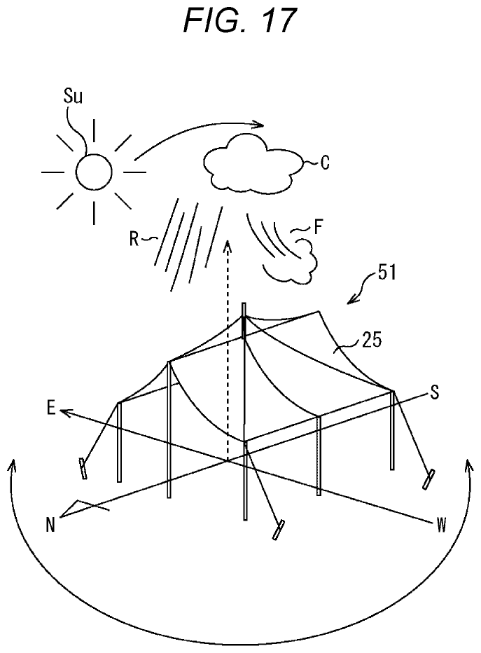

Next, presentation of set-up conditions including the direction and attitude of the residential structure 51 optimum for power generation by the information processing apparatus 91 will be described with reference to FIG. 17.

As illustrated in FIG. 17, in the residential structure 51, it is possible to improve power generation efficiency by efficiently receiving sunlight applied to the cloth-like part 95. Therefore, the power generation efficiency can be improved by adjusting the set-up condition including the direction and attitude (inclination) of the cloth-like part 95 with respect to sun Su and cloud C on the basis of the surrounding topography based on the position information.

In addition, in the residential structure 51, the residential space is configured by the cloth-like part 95, but the environment load on the cloth-like part 95 can be reduced by adjusting the set-up conditions including the direction and attitude (inclination) of the cloth-like part 95 according to the direction and strength of precipitation R and wind F.

The environment load on the cloth-like part 95 is a load generated according to the environment on the cloth-like part 95, and is, for example, a windproof load against strong wind.

Therefore, the control unit 111 estimates the environment conditions such as the sun Su, the cloud C, the precipitation R, and the wind F on the basis of the information of the surrounding topography based on its own position information, various types of environment information acquired by the environment sensor 93, and various types of environment information acquired via the communication unit 112.

Then, the control unit 111 calculates the power generation efficiency and the environment load of the cloth-like part 95 when the set-up condition including the direction and the attitude of the residential structure 51 is changed under the environment condition that is the estimation result, and obtains and presents the set-up condition specifying the direction and the attitude of the residential structure 51 that optimize the power generation efficiency and the environment load from the calculation result.

Here, the information indicating the direction of the residential structure 51 is, for example, a set-up direction of the residential structure 51 indicated by a curved arrow in FIG. 17, and is, for example, information indicating which direction of east, west, north, and south (EWSN) the front direction of the residential structure 51 is set to.

In addition, the information on the attitude of the residential structure 51 is, for example, the direction of the surface of the cloth-like part 95 of the residential structure 51 in FIG. 17, the height of the pole 99 for adjusting the direction of the cloth-like part 95, and the magnitude of the tension of the conductive rope 96, and the like.

By changing the set-up condition of the residential structure 51 on the basis of the set-up condition including the direction and the attitude according to such presentation, it is possible to take measures against the environment load while improving the power generation efficiency.

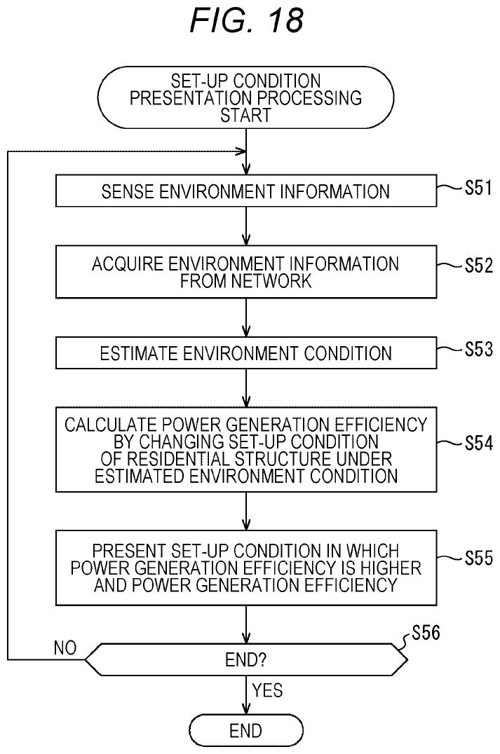

As a result, it is possible to secure the safety of the residential structure 51 against the environment load while securing the power generation amount. <Set-up Condition Presentation Processing>Next, the set-up condition will be described with reference to a flowchart in FIG. 18.

In step S51, the control unit 111 controls the environment sensor 93 to acquire sensing results on various types of environment information.

In step S52, the control unit 111 controls the communication unit 112 to access, for example, a server or the like that provides, for example, environment information via the hub 141 and the network 33 via the conductive rope 98, and acquires various types of environment information.

In step S53, the control unit 111 estimates an environment condition, after a predetermined time elapses, of the area in which the residential structure 51 is set up on the basis of the topography information based on the position information, the environment information acquired from the environment sensor 93, and the environment information acquired via the network 33.

In step S54, the control unit 111 calculates the power generation efficiency and the environment load by changing the set-up conditions of the residential structure 51 under the estimated environment conditions after a predetermined time elapses.

In step S55, the control unit 111 causes the display unit 92 to present the set-up condition in which the power generation efficiency is higher than a predetermined order under the condition that the environment load does not exceed the predetermined value. That is, the control unit 111 causes the display unit 92 to present the set-up condition in which the power generation efficiency is higher than a predetermined order among the set-up conditions that can secure safety without blowing off or crushing the residential structure 51 due to the environment load.

In step S56, the control unit 111 determines whether or not an instruction to end has been given, and in a case where the instruction to end has not been given, the process returns to step S51.

That is, the processes of steps S51 to S56 are repeated until the end is instructed.

Then, in a case where it is determined in step S56 that the end instruction has been given, the process ends. According to the above processing, it is possible to present the set-up condition including the direction and attitude of the residential structure 51 in consideration of the environment load and the power generation efficiency on the basis of the estimation result of the environment condition.

As a result, it is possible to set up the residential structure 51 under the set-up conditions with high power generation efficiency while ensuring safety according to the environment load.

Note that a mechanism may be provided to adjust the length of the pole 99 and the tension of the conductive rope 98 according to driving of a motor or the like. In a case where such a mechanism is adopted, the motor may be driven to adjust the length and the tension of the conductive rope so that the presented power generation efficiency satisfies the highest set-up condition.

<<9. Power Feeding Control for Assigning Power>>

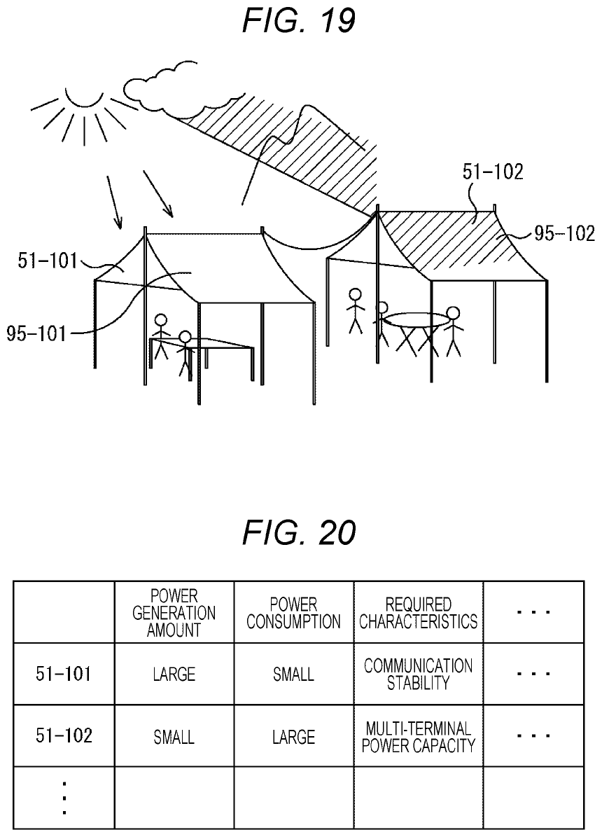

Next, a description will be given of power feeding control for assigning power depending on the power generation amount and the power consumption between the residential structures 51 in the same cluster 31 with reference to FIGS. 19 and 20.

For example, as illustrated in FIG. 19, at a predetermined timing, the residential structure 51-101 is in a state of receiving sufficient sunlight with respect to the cloth-like part 95-101, and the residential structure 51-102 is in a state of being shaded with respect to the cloth-like part 95-102 and not receiving sunlight.

In addition, a case where the power consumption in the residential structure 51-101 is small and the power consumption in the residential structure 51-102 is large will be considered.

Such a situation can be expressed by, for example, a table as illustrated in FIG. 20.

That is, the residential structure 51-101 has a large power generation amount and small power consumption.

In addition, the residential structure 51-102 has a large power generation amount and small power consumption.

Here, it is further assumed that the required characteristic of the residential structure 51-101 is communication stability, and the required characteristic of the residential structure 51-102 is multi-terminal power capacity.

In such a case, in the residential structure 51-101, since the power generation amount is large and the power consumption is small, surplus power is generated with respect to the power generation amount.

Meanwhile, in the residential structure 51-102, since the power generation amount is large and the power consumption is small, an insufficient power generation amount is generated.

However, in the residential structures 51-101, on the basis of the required characteristics, even if the power consumption is small, there is no effect as long as the communication stability is maintained.

Further, in the residential structure 51-102, since it may be essential to secure the multi-terminal power capacity on the basis of the required characteristics, it is considered that the large power consumption is normal. Therefore, in such a case, the residential structures 51-102 request the other residential structures 51 to accommodate the electric power so that the power consumption is not insufficient.

Here, the residential structure 51-101 may be assigned to the residential structure 51-102 for more surplus electric power as long as the electric power for maintaining the communication stability can be secured. Therefore, the residential structure 51-101 makes the surplus electric power be assigned to the residential structure 51-102 via the conductive rope 98 and the hub 141 in response to the request from the residential structure 51-102.

By such processing, it is possible to cover the shortage with surplus power among a plurality of residential structures 51 in the cluster 31, and it is possible to realize a stable power supply for all the residential structures 51 in the cluster 31.

Note that, in this power supply, when power shortage occurs, the operation of the information processing apparatus 91 is stopped, and there is a possibility that the processing is difficult to be implemented.

Therefore, it is desirable to be able to perform assignment in advance based on the environment conditions estimated on the basis of the environment information acquired via the environment sensor 93 or the network 33 and the power consumption estimated on the basis of the past power use record and the like.

<Supply Control Processing>

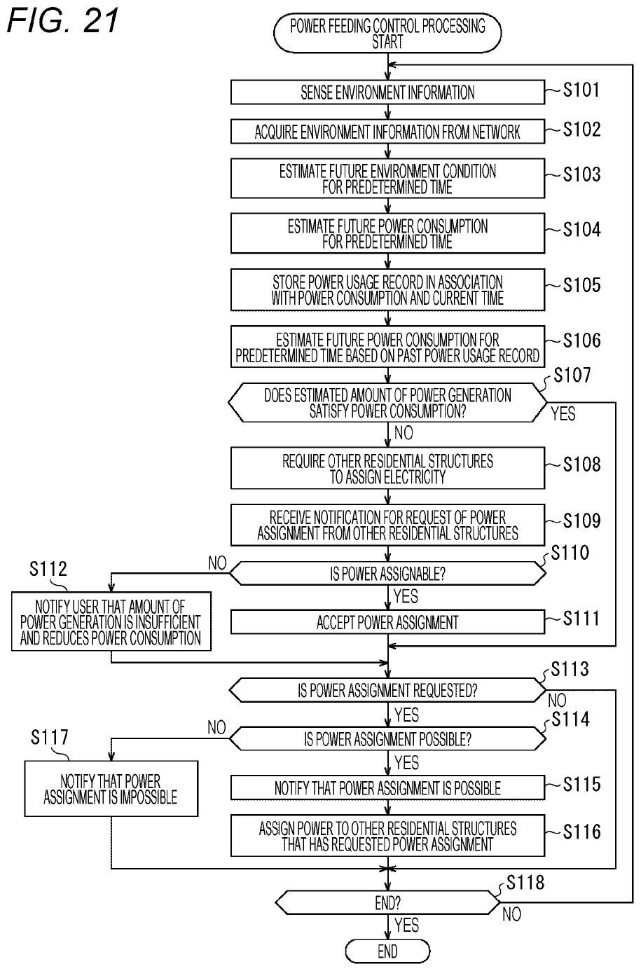

Next, the supply control processing will be described with reference to a flowchart in FIG. 21.

In step S101, the control unit 111 controls the environment sensor 93 to acquire sensing results on various types of environment information.

In step S102, the control unit 111 controls the communication unit 112 to access, for example, a server (not illustrated) or the like that provides, for example, environment information via the hub 141 and the network 33 via the conductive rope 98, and acquires various types of environment information.

In step S103, the control unit 111 estimates an environment condition, after a predetermined time elapses, of the area in which the residential structure 51 is set up on the basis of the surrounding topography based on the position information, the environment information acquired from the environment sensor 93, and the environment information acquired via the network 33.

In step S104, the control unit 111 estimates a power generation amount after a predetermined time elapses under the estimated environment conditions.

In step S105, the control unit 111 controls the power feeding unit 101 to store the current power consumption and the current time in the storage unit 113 as the actual power consumption by associating the current power consumption with the current time.

In step S106, the control unit 111 estimates the power consumption after a predetermined time elapses on the basis of the past power use record stored in the storage unit 113.

In step S107, the control unit 111 determines whether or not the estimated power generation amount satisfies the estimated power consumption and can be covered. In this case, the control unit 111 makes the determination in consideration of the required conditions and the like of the residential structure 51 in FIG. 20 as necessary.

In a case where it is determined in step S107 that the estimated power generation amount does not satisfy the estimated power consumption and is difficult to be covered, the process proceeds to step S108.

In step S108, the control unit 111 controls the communication unit 112 to transmit a notification for requesting the power assignment to the other residential structures 51 in the same cluster 31.

In step S109, the control unit 111 controls the communication unit 112 to receive a notification of a request for power assignment from the other residential structure 51 in the same cluster 31.

In step S110, the control unit 111 determines whether or not the power assignment is performed on the basis of the received notification of the power assignment request from the other residential structure 51 in the same cluster 31.

Here, the control unit 111 determines whether or not the assignment is possible depending on whether or not the sum of the amounts of electricity to which the power assignment is possible from the individual other residential structures 51 can cover the insufficient power consumption.

In a case where it is determined in step S110 that the power assignment is performed, the process proceeds to step S111.

In step S111, the control unit 111 controls the power feeding unit 101 to receive the assigned power via the conductive rope 98. In this case, the control unit 111 may display, on the display unit 92, an image prompting cooperation in power saving as necessary since the power assignment is received.

On the other hand, in a case where it is determined in step S110 that the power is not assigned, the process proceeds to step S112.

In step S112, the control unit 111 displays, on the display unit 92, an image notifying that there is a possibility that the power consumption may not be covered due to a decrease in the power generation amount after a predetermined time elapses. In this case, the control unit 111 may shut down electrical appliances with low priority in ascending order of priority as necessary.

On the other hand, in a case where it is determined in step S107 that the estimated power consumption is satisfied with the estimated power generation amount and can be covered, the processes of steps S108 to S112 are skipped.

In step S113, the control unit 111 controls the communication unit 112 to determine whether or not a notification of a request for power assignment has been transmitted from another residential structure 51 in the same cluster 31.

In step S113, in a case where the notification requesting the power assignment is transmitted from the other residential structure 51 in the same cluster 31, the process proceeds to step S114.

In step S114, the control unit 111 determines whether or not the estimated power generation amount is sufficient for the estimated power consumption and is capable of assignment to the other residential structure 51. In this case, the control unit 111 makes a determination in consideration of the required conditions and the like in FIG. 20.

In a case where it is determined in step S114 that the power assignment is possible, the process proceeds to step S115.

In step S115, the control unit 111 controls the communication unit 112 to notify the other residential structure 51 requesting the power assignment of the notification indicating that the power assignment is possible. In this case, the control unit 111 also notifies information on the assignable power amount.

In step S116, the control unit 111 controls the power feeding unit 101 to assign the power to the other residential structure 51 that requests the power assignment.

On the other hand, in a case where it is determined in step S114 that the power assignment is not possible, the process proceeds to step S117.

In step S117, the control unit 111 controls the communication unit 112 to notify the other residential structure 51 requesting the power assignment of the notification indicating that the power assignment is not possible.

Note that in step S113, in a case where the notification that requests the power assignment is not transmitted from the residential structure 51 in the same cluster 31, steps S114 to S117 are skipped.

In step S118, the control unit 111 determines whether or not the end of the process has been instructed, and in a case where the end of the process has not been instructed, the process returns to step S101, and the subsequent processes are repeated.

Then, in a case where the end of the process is instructed in step S118, the process ends.

That is, by the series of processes described above, in the same cluster 31, the residential structure 51 having a sufficient power generation amount and surplus power can assign power to the residential structure 51 having an insufficient power generation amount, and power can be stably supplied to the entire residential structures 51 in the cluster 31.

Note that in the above description, the power feeding control is performed to realize the power assignment between the residential structures 51 in the same cluster 31, but the similar power feeding control may be performed between different clusters 31.

In addition, for example, a cloud server or the like that implements the power feeding control may be configured on the network 33, and the power consumption may be grasped from the power generation amounts of all the residential structures 51 in the cluster 31, so the cloud server may control the power assignment between the residential structures 51.

<<10. Example Executed by Software>>

Meanwhile, the above-described series of processes can be executed by hardware, but can also be executed by software. In a case where the series of processes are executed by software, a program constituting the software is installed from a recording medium to a computer incorporated in dedicated hardware or, for example, a general-purpose computer or the like capable of executing various functions by installing various programs.

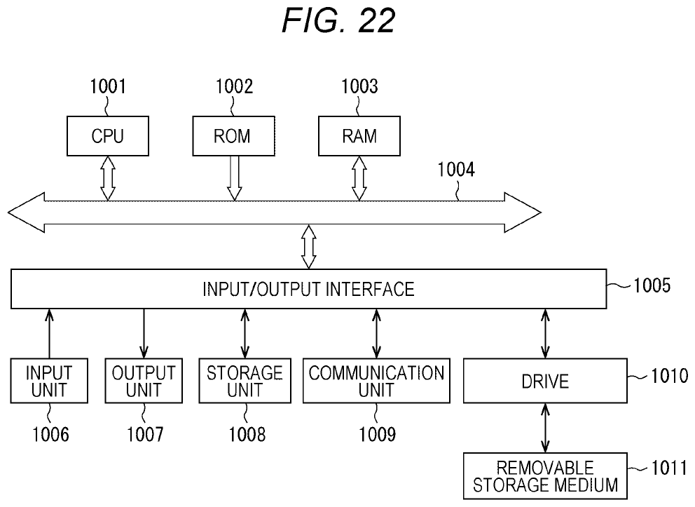

FIG. 22 illustrates a configuration example of a general-purpose computer. The personal computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

The input/output interface 1005 is connected with an input unit 1006 including an input device such as a keyboard or a mouse with which a user inputs an operation command, an output unit 1007 that outputs a processing operation screen or an image of a processing result to a display device, a storage unit 1008 including a hard disk drive or the like that stores a program or various data, and a communication unit 1009 that includes a local area network (LAN) adapter or the like and executes communication processing via a network represented by the Internet. Furthermore, a drive 1010 that reads and writes data from and to a removable storage medium 1011 such as a magnetic disk (including a flexible disk), an optical disk (including a compact disc-read only memory (CD-ROM) and a digital versatile disc (DVD)), a magneto-optical disk (including a mini disc (MD)), or a semiconductor memory is connected.

The CPU 1001 executes various processes according to a program stored in the ROM 1002 or a program that is read from a removable storage medium 1011 such as a magnetic disk, an optical disk, a magneto-optical disk, or a semiconductor memory, installed in the storage unit 1008, and loaded from the storage unit 1008 to the RAM 1003.

The RAM 1003 also appropriately stores data and the like necessary for the CPU 1001 to execute various processes. In the computer configured as described above, the CPU 1001 loads and executes the program recorded in the storage unit 1008 into the RAM 1003 via the input/output interface 1005 and the bus 1004, thereby executing the above-described series of processes.

The program executed by the computer (CPU 1001) can be recorded and provided on the removable storage medium 1011 as a package medium or the like, for example. In addition, the program can also be provided via a wired or wireless transmission medium such as a local area network, the Internet, or digital satellite broadcasting. In the computer, the program can be installed in the storage unit 1008 via the input/output interface 1005 by mounting the removable storage medium 1011 in the drive 1010. Further, the program can be received by the communication unit 1009 and installed in the storage unit 1008 via the wired or wireless transmission medium. In addition, the program can be installed in advance in the ROM 1002 or the storage unit 1008.

Note that the program executed by the computer may be a program in which processing is performed in time series in the order described in the present specification, or may be a program in which processing is performed in parallel or at necessary timing such as when a call is made.

Note that the CPU 1001 in FIG. 22 implements the function of the control unit 111 in FIG. 4.

Further, in the present specification, the system means a set of a plurality of components (devices, modules (parts), etc.), and it does not matter whether or not all the components are in the same housing. Therefore, any of a plurality of devices housed in separate housings and connected via a network and one device in which a plurality of modules are housed in one housing are systems.

Note that the embodiment of the present disclosure is not limited to the above-described embodiment, and various changes can be made without departing from the gist of the present disclosure.

For example, the present disclosure can be configured as cloud computing in which one function is shared by a plurality of devices via a network and processed jointly. Further, each step described in the above-described flowchart can be not also executed by one device, but can also be shared and executed by a plurality of devices.

Furthermore, in a case where one step includes a plurality of processes, the plurality of processes included in the one step can be executed by one device or shared and executed by a plurality of devices.

Note that the present disclosure may also be configured as below.

<1>A residential structure in which a residential space is constituted by a cloth-like member including a cloth-like base material,

a holding member that is stacked on the base material, and

a plurality of panels that are stacked on the holding member and generate power by sunlight,

the plurality of panels is regularly arranged on a plane at predetermined intervals,

the holding member is arranged on the base material in substantially the same size as the panel and at substantially the same position as the panel, and a stretchable member is arranged on the base material between the holding members.

<2> The residential structure described in <1>, in which the stretchable member includes a resin material.

<3> The residential structure described in <1> or <2>, in which

the plurality of panels has the same shape.

<4> The residential structure described in <3>, in which the panel has a substantially right-angled isosceles triangle.

<5> The residential structure described in <4>, in which the panels are arranged in a matrix form in a horizontal direction and a vertical direction in units of groups each formed every four panels, and

the group is formed in a rectangular shape as a whole by being arranged so that right-angled vertexes of the substantially right-angled isosceles triangles of the four panels face each other, and being arranged so that isosceles sides of adjacent panels face each other adjacently.

<6> The residential structure described in <2>, in which the panel has a substantially equilateral triangle.

<7> The residential structure described in <6>, in which each side of the substantially equilateral triangle is arranged in a planar shape so as to be adjacent to and face each other.

<8> The residential structure described in any one of <1> to <7>, further including

a conductive rope that applies tension necessary for making the cloth-like member into a spread state for use as a ceiling in the residential space and supplies a ground potential to the cloth-like member.

<9> The residential structure described in <8>, in which the conductive rope has a configuration in which a rope that withstands a predetermined tensile strength and a conductive metal lead are integrated.

<10> The residential structure described in <9>, in which the conductive rope has a configuration in which the rope and the lead are integrated in a state in which axes of the rope and the lead are different from each other.

<11> The residential structure described in <9>, in which the conductive rope has a configuration in which the rope and the lead are integrated in a state in which the axes of the rope and the lead are coaxial.

<12> The residential structure described in <9>, further including:

a solid stake that includes a claw part that supports the tension related to the rope, and a grounding part that electrically grounds the lead, and is driven into the ground.

<13> The residential structure described in any one of <1> to <12>, further including:

a communication unit that communicates with other residential structures; and

a control unit that controls the communication unit to realize a telepresence function by communication with the other residential structures using power generated by the panel.

<14> The residential structure described in <13>, in which

the control unit

estimates an environment condition after a predetermined time elapses around the residential structure on the basis of environment information,

estimates a power generation amount by the cloth-like member while changing set-up conditions of the residential structure under the estimated environment conditions, and

presents the set-up condition in which the power generation amount is higher than a predetermined order among the estimated set-up conditions.

<15> The residential structure described in <14>, in which

the control unit

estimates the power generation amount by the panel and an environment load on the residential structure while changing the set-up conditions of the residential structure under the estimated environment conditions, and presents the set-up condition in which the power generation amount is higher than the predetermined order among the set-up conditions capable of securing safety of the residential structure based on the environment load.

<16> The residential structure described in <13>, in which

the control unit

estimates a power generation amount by the cloth-like member after a predetermined time elapses, and estimates power consumption after the predetermined time elapses, and

requests power assignment from the other residential structures and accepts the power assignment from the other residential structures in a case where the power generation amount does not satisfy the power consumption after the predetermined time elapses.

<17> The residential structure described in <13>, in which

the control unit assigns the power generated by the cloth-like member to the other residential structures in a case where the power assignment is requested from the other residential structures.

<18> The residential structure described in <17>, in which

the control unit

estimates a power generation amount by the cloth-like member after a predetermined time elapses, and estimates power consumption after the predetermined time elapses, and

assigns the power generated by the cloth-like member to the other residential structures when the power assignment is requested from the other residential structures in a case where the power generation amount satisfies the power consumption after the predetermined time elapses.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

11 Telepresence system
31, 31-1 to 31-q, 32 Cluster
51, 51-1 to 51-n, 51′, 51′-1 to 51′-n Residential structure
90, 90′ Battery
91, 91′ Information processing apparatus
92, 92′ Display unit
92a, 92a′ Imaging unit
93, 93′ Environment sensor
94, 94′ Antenna
95, 95′ Cloth-like part
96, 96-1 to 96-n, 96′, 96′-11 to 96′-14 Conductive rope
97, 97-1 to 97-n, 97′, 97′-11 to 97′-14 Solid stake
98, 98′ Conductive rope
99, 99-1 to 99-n, 99′, 99′-11, 99′-12 Pole
101, 101′ Power feeding unit
111 Control unit
112 Communication unit
113 Storage unit

1. A residential structure, wherein a residential space is constituted by a cloth-like member including
a cloth-like base material,
a holding member that is stacked on the base material, and
a plurality of panels that are stacked on the holding member and generate power by sunlight,
the plurality of panels is regularly arranged on a plane at predetermined intervals,
the holding member is arranged on the base material in substantially the same size as the panel and at substantially the same position as the panel, and
a stretchable member is arranged on the base material between the holding members.

2. The residential structure according to claim 1, wherein
the stretchable member includes a resin material.

3. The residential structure according to claim 1, wherein
the plurality of panels has the same shape.

4. The residential structure according to claim 3, wherein
the panel has a substantially right-angled isosceles triangle.

5. The residential structure according to claim 4, wherein
the panels are arranged in a matrix form in a horizontal direction and a vertical direction in units of groups each formed every four panels, and
the group is formed in a rectangular shape as a whole by being arranged so that right-angled vertexes of the substantially right-angled isosceles triangles of the four panels face each other, and being arranged so that isosceles sides of adjacent panels face each other adjacently.

6. The residential structure according to claim 2, wherein
the panel has a substantially equilateral triangle.

7. The residential structure according to claim 6, wherein
each side of the substantially equilateral triangle is arranged in a planar shape so as to be adjacent to and face each other.

8. The residential structure according to claim 1, further comprising:
a conductive rope that applies tension necessary for making the cloth-like member into a spread state for use as a ceiling in the residential space and supplies a ground potential to the cloth-like member.

9. The residential structure according to claim 8, wherein
the conductive rope has a configuration in which a rope that withstands a predetermined tensile strength and a conductive metal lead are integrated.

10. The residential structure according to claim 9, wherein
the conductive rope has a configuration in which the rope and the lead are integrated in a state in which axes of the rope and the lead are different from each other.

11. The residential structure according to claim 9, wherein
the conductive rope has a configuration in which the rope and the lead are integrated in a state in which the axes of the rope and the lead are coaxial.

12. The residential structure according to claim 9, further comprising:
a solid stake that includes a claw part that supports the tension related to the rope, and a grounding part that electrically grounds the lead, and is driven into the ground.

13. The residential structure according to claim 1, further comprising:
a communication unit that communicates with other residential structures; and
a control unit that controls the communication unit to realize a telepresence function by communication with the other residential structures using power generated by the panel.

14. The residential structure according to claim 13, wherein
the control unit
estimates an environment condition after a predetermined time elapses around the residential structure on a basis of environment information,
estimates a power generation amount by the cloth-like member while changing set-up conditions of the residential structure under the estimated environment conditions, and
presents the set-up condition in which the power generation amount is higher than a predetermined order among the estimated set-up conditions.

15. The residential structure according to claim 14, wherein
the control unit
estimates the power generation amount by the panel and an environment load on the residential structure while changing the set-up conditions of the residential structure under the estimated environment conditions, and
presents the set-up condition in which the power generation amount is higher than the predetermined order among the set-up conditions capable of securing safety of the residential structure based on the environment load.

16. The residential structure according to claim 13, wherein
the control unit
estimates a power generation amount by the cloth-like member after a predetermined time elapses, and
estimates power consumption after the predetermined time elapses, and
requests power assignment from the other residential structures and accepts the power assignment from the other residential structures in a case where the power generation amount does not satisfy the power consumption after the predetermined time elapses.

17. The residential structure according to claim 13, wherein
the control unit assigns the power generated by the cloth-like member to the other residential structures in a case where the power assignment is requested from the other residential structures.

18. The residential structure according to claim 17, wherein
the control unit
estimates a power generation amount by the cloth-like member after a predetermined time elapses, and
estimates power consumption after the predetermined time elapses, and
assigns the power generated by the cloth-like member to the other residential structures when the power assignment is requested from the other residential structures in a case where the power generation amount satisfies the power consumption after the predetermined time elapses.
